(19) United States
(12) Patent Application Publication
(10) Pub. No.: US 2011/0128239 A1
(43) Pub. Date: Jun. 2, 2011

(54) ELECTROACTIVE POLYMER TRANSDUCERS FOR TACTILE FEEDBACK DEVICES

(75) Inventors: Ilya POLYAKOV, San Francisco, CA (US); Jonathan R. HEIM, Pacifica, CA (US)

(73) Assignee: Bayer MaterialScience AG, Leverkusen (DE)

(21) Appl. No.: 12/785,363

(22) Filed: May 21, 2010

Related U.S. Application Data
(63) Continuation of application No. PCT/US2008/084430, filed on Nov. 21, 2008.
(60) Provisional application No. 60/989,695, filed on Nov. 21, 2007.

(51) Int. Cl. G06F 3/041

(52) U.S. Cl. 345/173; 340/407.2

(57) ABSTRACT

Electroactive polymer transducers for sensory feedback applications in user interface devices are disclosed.

### RELATED APPLICATIONS

The present application is a continuation of International Application Number PCT/US2008/084430, filed Nov. 21, 2008, which claims the benefit of U.S. Provisional Application No. 60/989,695 filed Nov. 21, 2007 entitled “TACTILE FEEDBACK DEVICE”, the contents of which is incorporated herein by reference in their entireties.

### FIELD OF THE INVENTION

The present invention is directed to the use of electroactive polymer transducers to provide sensory feedback.

### BACKGROUND

There are many known user interface devices which employ haptic feedback (the communication of information to a user through forces applied to the user's body), typically in response to a force initiated by the user. Examples of user interface devices that may employ haptic feedback include keyboards, touch screens, computer mice, trackballs, stylus sticks, joysticks, etc. The haptic feedback provided by these types of interface devices is in the form of physical sensations, such as vibrations, pulses, spring forces, etc., which a user senses either directly (e.g., via touching of the screen), indirectly (e.g., via a vibrational effect such a when a cell phone vibrates in a purse or bag) or otherwise sensed (e.g., via an action of a moving body that creates a pressure disturbance but doe not generate an audio signal in the traditional sense)

Often, a user interface device with haptic feedback can be an input device that “receives” an action initiated by the user as well as an output device that provides haptic feedback indicating that the action was initiated. In practice, the position of some contacted or touched portion or surface, e.g., a button, of a user interface device is changed along at least one degree of freedom by the force applied by the user, where the force applied must reach some minimum threshold value in order for the contacted portion to change positions and to effect the haptic feedback. Achievement or registration of the change in position of the contacted portion results in a responsive force (e.g., spring-back, vibration, pulsing) which is also imposed on the contacted portion of the device acted upon by the user, which force is communicated to the user through his or her sense of touch.

One common example of a user interface device that employs a spring-back or “bi-phase” type of haptic feedback is a button on a mouse. The button does not move until the applied force reaches a certain threshold, at which point the button moves downward with relative ease and then stops—the collective sensation of which is defined as “clicking” the button. The user-applied force is substantially along an axis perpendicular to the button surface, as is the responsive (but opposite) force felt by the user.

In another example, when a user enters input on a touch screen the, screen confirms the input typically by a graphical change on the screen along with/without an auditory cue. A touch screen provides graphical feedback by way of visual cues on the screen such as color or shape changes. A touch pad provides visual feedback by means of a cursor on the screen. While above cues do provide feedback, the most intuitive and effective feedback from a finger actuated input device is a tactile one such as the detent of a keyboard key or the detent of a mouse wheel. Accordingly, incorporating haptic feedback on touch screens is desirable.

Haptic feedback capabilities are known to improve user productivity and efficiency, particularly in the context of data entry. It is believed by the inventors hereof that further improvements to the character and quality of the haptic sensation communicated to a user may further increase such productivity and efficiency. It would be additionally beneficial if such improvements were provided by a sensory feedback mechanism which is easy and cost-effective to manufacture, and does not add to, and preferably reduces, the space, size and/or mass requirements of known haptic feedback devices.

### SUMMARY OF THE INVENTION

The present invention includes devices, systems and methods involving electroactive transducers for sensory applications. In one variation, a user interface device having sensory feedback is provided. One benefit of the present invention is to provide the user of a touch screen or touchpad equipped electronic device with a means of tactile feedback whenever an input on a sensor plate is triggered or an actuator is triggered by software. The touch screen can be rigid or flexible depending upon the desired application for which the user interface device is to be used.

In one variation, the systems described herein include a user interface device for displaying information to a user, the user interface comprising a screen having a user interface surface configured for tactile contact by a user and a sensor plate, the screen being configured to display the information; a frame about at least a portion of the screen; and an electroactive polymer material coupled between the screen and the frame, wherein an input signal generated by the user causes an electrical field to be applied to the electroactive polymer material causing the electroactive polymer material to displace at least one of the screen and sensor panel in a manner that produces a force sufficient for tactile observation by the user.

The user interface device described herein can be configured for tactile contact by a user, and where tactile contact by the user results in generation of the input signal. Alternatively, or in addition, the user interface device can be configured to accept user input and for generation of the input signal.

The systems described herein, will generally also comprise a control system for controlling the amount of displacement of the electroactive polymer transducer in response to a triggering force against the screen. The movement of the screen can be in any number of directions. For example, in a lateral direction relative to the frame, axially relative to the frame, or both.

In some variations, the electroactive polymer material is encapsulated to form a gasket and where the gasket is mechanically coupled between the frame and the screen.

The electroactive polymer material can be coupled between the frame and the screen in any number of configurations. The coupling can include at least one spring member located between the frame and the screen.

In some variations of the device, the electroactive polymer material comprises at least an electro active transducer having at least one spring member.

In an additional variation, the electroactive polymer material comprises a plurality of corrugations or folds.

In another variation of the user interface device. The device includes a screen having a sensor surface configured for tactile contact by a user and a sensor plate, the screen being configured to display the information, a frame about at least a portion of the screen, and an electroactive polymer material coupled between the sensor surface and the frame, wherein an input signal generated by the user causes an electrical field to be applied to the electroactive polymer material causing the electroactive polymer material to displace at least one of the screen and sensor panel in a manner that produces a force sufficient for tactile observation by the user.

The present devices and systems provide greater versatility as they can be employed within many types of input devices and provide feedback from multiple input elements. The system is also advantageous, as it does not add substantially to the mechanical complexity of the device or to the mass and weight of the device. The system also accomplishes its function without any mechanical sliding or rotating elements thereby making the system durable, simple to assemble and easily manufacturable.

The present invention may be employed in any type of user interface device including, but not limited to, touch pads, touch screens or key pads or the like for computer, phone, PDA, video game console, GPS system, kiosk applications, etc.

As for other details of the present invention, materials and alternate related configurations may be employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

These and other features, objects and advantages of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying schematic drawings. To facilitate understanding, the same reference numerals have been used (where practical) to designate similar elements that are common to the drawings. Included in the drawings are the following:

FIGS. 1A and 1B illustrate some examples of a user interface that can employ haptic feedback when an EAP transducer is coupled to a display screen or sensor and a body of the device.

FIGS. 2A and 2B, show a sectional view of a user interface device including a display screen having a surface that reacts with haptic feedback to a user's input.

FIGS. 3A and 3B illustrate a sectional view of another variation of a user interface device having a display screen covered by a flexible membrane with active EAP formed into active gaskets.

FIG. 4 illustrates a sectional view of an additional variation of a user interface device having a spring biased EAP membrane located about an edge of the display screen.

FIG. 5 shows a sectional view of a user interface device where the display screen is coupled to a frame using a number of compliant gaskets and the driving force for the display is a number of EAP actuators diaphragms.

FIGS. 6A and 6B show sectional views of a user interface 230 having a corrugated EAP membrane or film coupled between a display.

FIGS. 7A and 7B illustrate a top perspective view of a transducer before and after application of a voltage in accordance with one embodiment of the present invention.

FIGS. 8A and 8B show exploded top and bottom perspective views, respectively, of a sensory feedback device for use in a user interface device.

FIG. 9A is a top planar view of an assembled electroactive polymer actuator of the present invention; FIGS. 9B and 9C are top and bottom planar views, respectively, of the film portion of the actuator of FIG. 8A and, in particular, illustrate the two-phase configuration of the actuator.

FIGS. 9D and 9E illustrate an example of arrays of electro active polymer transducer for placing across a surface of a display screen that is spaced from a frame of the device.

FIGS. 9F and 9G are an exploded view and assembled view, respectively, of an array of actuators for use in a user interface device as disclosed herein.

FIG. 10 illustrates a side view of the user interface devices with a human finger in operative contact with the contact surface of the device.

FIGS. 11A and 11B graphically illustrate the force-stroke relationship and voltage response curves, respectively, of the actuator of FIGS. 9A-9C when operated in a single-phase mode.

FIGS. 12A and 12B graphically illustrate the force-stroke relationship and voltage response curves, respectively, of the actuator of FIGS. 9A-9C when operated in a two-phase mode.

FIG. 13 is a block diagram of electronic circuitry, including a power supply and control electronics, for operating the sensory feedback device.

FIGS. 14A and 14B shows a partial cross sectional view of an example of a planar array of EAP actuators coupled to a user input device.

Variation of the invention from that shown in the figures is contemplated.

### DETAILED DESCRIPTION OF THE INVENTION

The devices, systems and methods of the present invention are now described in detail with reference to the accompanying figures.

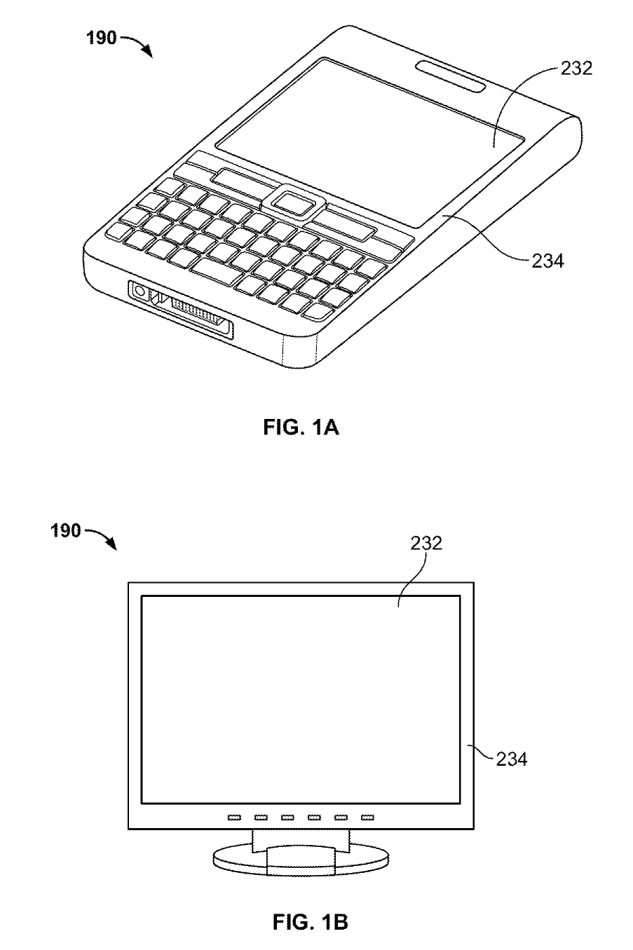

As noted above, devices requiring a user interface can be improved by the use of haptic feedback on the user screen of the device. FIGS. 1A and 1B illustrate simple examples of such devices 190. Each device includes a display screen 232 for which the user enters or views data. The display screen is coupled to a body or frame 234 of the device. Clearly, any number of devices are included within the scope of this disclosure regardless of whether portable (e.g., cell phones, computers, manufacturing equipment, etc.) or affixed to other non-portable structures (e.g., the screen of an information display panel, automatic teller screens, etc.) For purposes of this disclosure, a display screen can also include a touchpad type device where user input or interaction takes place on a monitor or location away from the actual touchpad (e.g., a lap-top computer touchpad).

A number of design considerations favor the selection and use of advanced dielectric elastomer materials, also referred to as “electroactive polymers” (EAPs), for the fabrication of transducers especially when haptic feedback of the display screen 232 is sought. These considerations include potential force, power density, power conversion/consumption, size, weight, cost, response time, duty cycle, service requirements, environmental impact, etc. As such, in many applications, EAP technology offers an ideal replacement for piezoelectric, shape-memory alloy (SMA) and electromagnetic devices such as motors and solenoids.

An EAP transducer comprises two thin film electrodes having elastic characteristics and separated by a thin elastomeric dielectric material. When a voltage difference is applied to the electrodes, the oppositely-charged electrodes attract each other thereby compressing the polymer dielectric layer therebetween. As the electrodes are pulled closer together, the dielectric polymer film becomes thinner (the z-axis component contracts) as it expands in the planar directions (the x- and y-axes components expand).

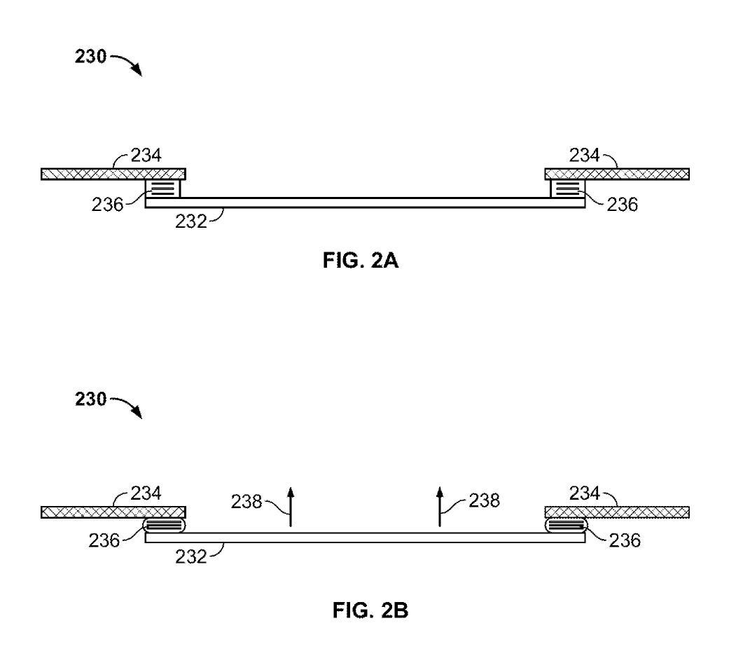

FIGS. 2A-2B, shows a portion of a user interface device 230 with a display screen 232 having a surface that is physically touched by the user in response to information, controls, or stimuli on the display screen. The display screen 234 can be any type of a touch pad or screen panel such as a liquid crystal display (LCD), organic light emitting diode (OLED) or the like. In addition, variations of interface devices 230 can include display screens 232 such as a “dummy” screen, where an image transposed on the screen (e.g., projector or graphical covering), the screen can include conventional monitors or even a screen with fixed information such as common signs or displays.

In any case, the display screen 232 includes a frame 234 (or housing or any other structure that mechanically connects the screen to the device via a direct connection or one or more ground elements), and an electroactive polymer (LAP) transducer 236 that couples the screen 232 to the frame or housing 234. As noted herein, the EAP transducers can be along an edge of the screen 232 or an array of EAP transducers can be placed in contact with portion of the screen 232 that are spaced away from the frame or housing 234.

FIGS. 2A and 2B illustrate a basic user interface device where an encapsulated EAP transducer 236 forms an active gasket. Any number of active gasket EAPs 236 can be coupled between the touch screen 232 and frame 234. Typically, enough active gasket EAPs 236 are provided to produce the desired haptic sensation. However, the number will often vary depending on the particular application. In a variation of the device, the touch screen 232 may either comprise a display screen or a sensor plate (where the display screen would be behind the sensor plate).

The figures show the user interface device 230 cycling the touch screen 232 between an inactive and active state. FIG. 2A shows the user interface device 230 where the touch screen 232 is in an inactive state. In such a condition, no field is applied to the EAP transducers 236 allowing the transducers to be at a resting state. FIG. 2B shows the user interface device 230 after some user input triggers the EAP transducer 236 into an active state where the transducers 236 cause the display screen 232 to move in the direction shown by arrows 238. Alternatively, the displacement of one or more EAP transducers 236 can vary to produce a directional movement of the display screen 232 (e.g., rather than the entire display screen 232 moving uniformly one area of the screen 232 can displace to a larger degree than another area). Clearly, a control system coupled to the user interface device 230 can be configured to cycle the EAPS 236 with a desired frequency and/or to vary the amount of deflection of the EAP 236.

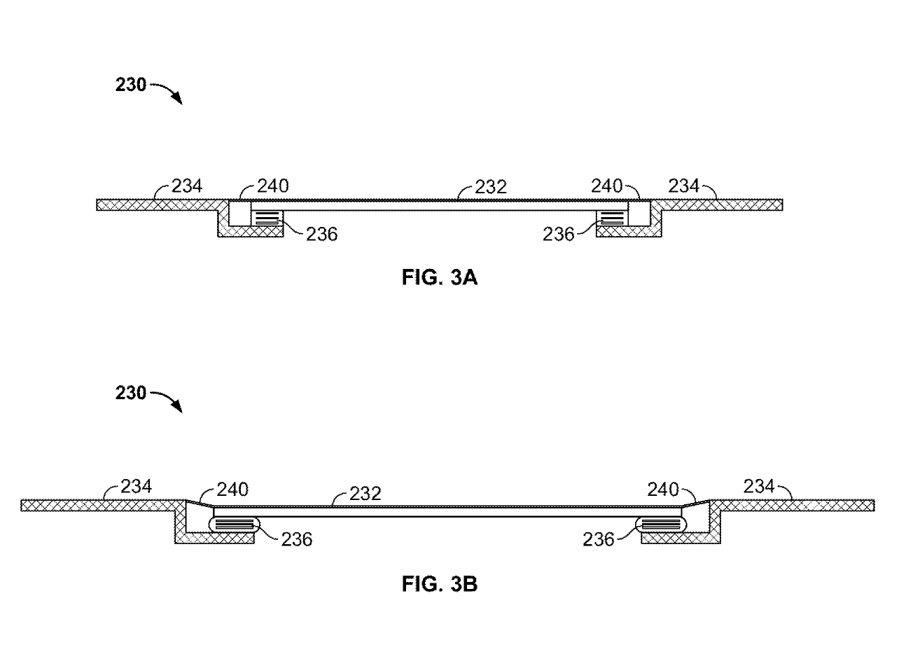

FIGS. 3A and 3B illustrate another variation of a user interface device 230 having a display screen 232 covered by a flexible membrane 240 that functions to protect the display screen 232. Again, the device can include a number of active gasket EAPs 236 coupling the display screen 232 to a base or frame 234. In response to a user input, the screen 232 along with the membrane 240 displaces when an electric field is applied to the EAPs 236 causing displacement so that the device 230 enters an active state.

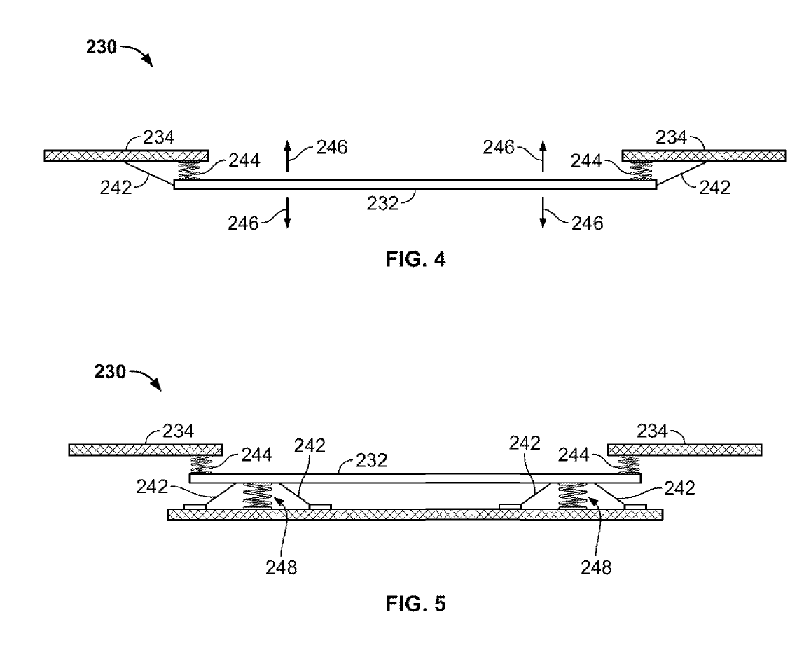

FIG. 4 illustrates an additional variation of a user interface device 230 having a spring biased EAP membrane 240 located about an edge of the display screen 232. The EAP membrane 240 can be placed about a perimeter of the screen or only in those locations that permit the screen to produce haptic feedback to the user. In this variation, a passive compliant gasket 244 provides a force against the screen 232 thereby placing the EAP membranes 242 in a state of tension. Upon providing an electric field 242 to the membrane (again, upon a signal generated by a user input), the EAP membranes 242 relax to cause displacement of the screen 232. As noted by arrows 246, the user input device 230 can be configured to produce movement of the screen 232 in any direction relative to the bias provided by the gasket 244. In addition, actuation of less than all the EAP membranes 242 produces non-uniform movement of the screen 232.

FIG. 5 illustrates yet another variation of a user interface device 230. In this example, the display screen 232 is coupled to a frame 234 using a number of compliant gaskets 244 and the driving force for the display 232 is a number of EAP actuators diaphragms 248. The EAP actuator diaphragms 248 are spring biased and upon. application of an electric field can drive the display screen. As shown, the EAP actuator diaphragms 248 have opposing EAP membranes on either side of a spring. In such a configuration, activating opposite sides of the EAP actuator diaphragms 248 makes the assembly rigid at a neutral point. The EAP actuator diaphragms 248 act like the opposing bicep and triceps muscles that control movements of the human arm. Though not shown, as discussed in U.S. patent application Ser. Nos. 11/085,798 and 11/085,804 the actuator diaphragms 248 can be stacked to provide two-phase output action and/or to amplify the output for use in more robust applications.

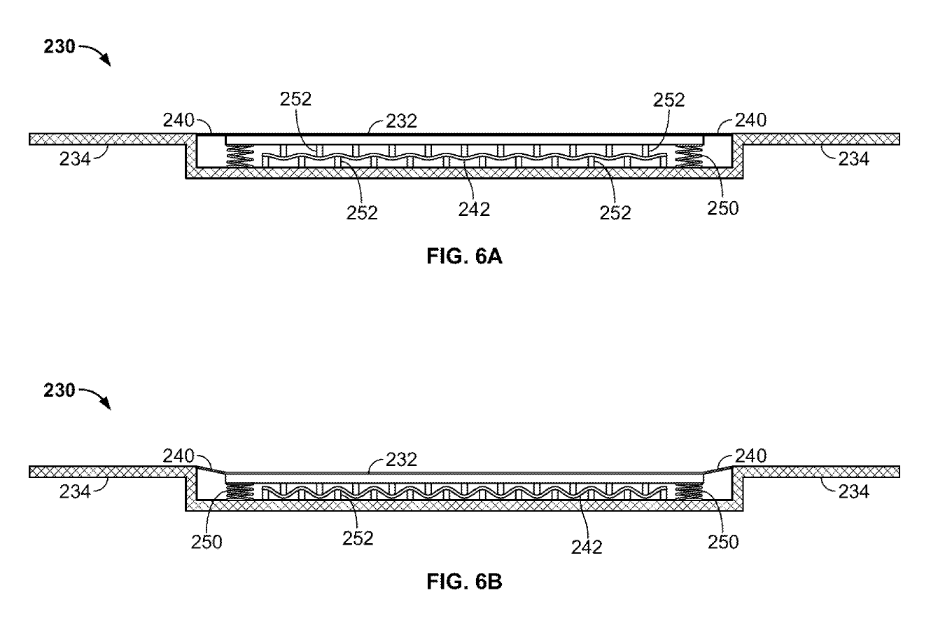

FIGS. 6A and 6B show another variation of a user interface 230 having an EAP membrane or film 242 coupled between a display 232 and a frame 234 at a number of points or ground elements 252 to accommodate corrugations or folds in the EAP film 242. As shown in FIG. 6B, the application of an electric field to the EAP film 242 causes displacement in the direction of the corrugations and deflects the display screen 232 relative to the frame 240. The user interface 232 can optionally include bias springs 250 also coupled between the display 232 and the frame 234 and/or a flexible protective membrane 240 covering a portion (or all) of the display screen 232.

It is noted that the figures discussed above schematically illustrate exemplary configurations of such tactile feedback devices that employ EAP films or transducers. Many variations are within the scope of this disclosure, for example, in variations of the device, the EAP transducers can be implemented to move only a sensor plate or element (e.g., one that is triggered upon user input and provides a signal to the EAP transducer) rather then the entire screen or pad assembly.

In any application, the feedback displacement of a display screen or sensor plate by the EAP member can be exclusively in-plane which is sensed as lateral movement, or can be out-of-plane (which is sensed as vertical displacement). Alternatively, the EAP transducer material may be segmented to provide independently addressable/movable sections so as to provide angular displacement of the plate element. In addition, any number of EAP transducers or films (as disclosed in the applications and patent listed above) can be incorporated in the user interface devices described herein.

The variations of the devices described herein allows the entire sensor plate (or display screen) of the device to act as a tactile feedback element. This allows for extensive versatility. For example, the screen can bounce once in response to a virtual key stroke or, it can output consecutive bounces in response to a scrolling element such as a slide bar on the screen, effectively simulating the mechanical detents of a scroll wheel. With the use of a control system, a three-dimensional outline can be synthesized by reading the exact position of the user's finger on the screen and moving the screen panel accordingly to simulate the 3D structure. Given enough screen displacement, and significant mass of the screen, the repeated oscillation of the screen may even replace the vibration function of a mobile phone. Such functionality may be applied to browsing of text where a scrolling (vertically) of one line of text is represented by a tactile “bump”, thereby simulating detents. In the context of video gaming, the present invention provides increased interactivity and finer motion control over oscillating vibratory motors employed in prior art video game systems. In the case of a touchpad, user interactivity and accessibility may be improved, especially for the visually impaired, by providing physical cues.

The EAP transducer may be configured to displace proportionally to an applied voltage, which facilitates programming of a control system used with the subject tactile feedback devices. For example, a software algorithm may convert pixel grayscale to EAP transducer displacement, whereby the pixel grayscale value under the tip of the screen cursor is continuously measured and translated into a proportional displacement by the EAP transducer. By moving a finger across the touchpad, one could feel or sense a rough 3D texture. A similar algorithm may be applied on a web page, where the border of an icon is fed back to the user as a bump in the page texture or a buzzing button upon moving a finger over the icon. To a normal user, this would provide an entirely new sensory experience while surfing the web, to the visually impaired this would add indispensable feedback.

EAP transducers are ideal for such applications for a number of reasons. For example, because of their light weight and minimal components, EAP transducers offer a very low profile and, as such, are ideal for use in sensory/haptic feedback applications. Examples of EAP transducers and their construction are described in U.S. Pat. Nos. 7,368,862; 7,362,031; 7,320,457; 7,259,503; 7,233,097; 7,224,106; 7,211,937; 7,199,501; 7,166,953; 7,064,472; 7,062,055; 7,052,594; 7,049.732; 7,034,432; 6,940,221; 6,911,764; 6,891,317; 6,882,086; 6,876,135; 6,812,624; 6,809,462; 6,806,621; 6,781,284; 6,768,246; 6,707,236; 6,664,718; 6,628,040; 6,586,859; 6,583,533; 6,545,384; 6,543,110; 6,376,971 and 6,343,129; and U.S. Published Patent Application Nos. 2006/0208610; 2008/0022517; 2007/0222344; 2007/0200468; 2007/0200467; 2007/0200466; 2007/0200457; 2007/0200454; 2007/0200453; 2007/0170822; 2006/0238079; 2006/0208610; 2006/0208609; and 2005/0157893, the entireties of which are incorporated herein by reference.

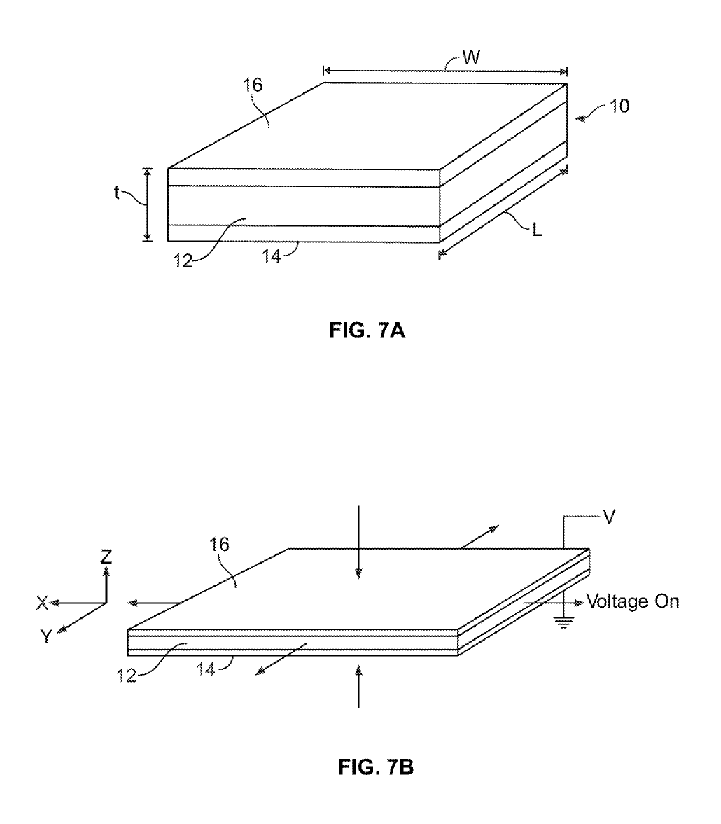

FIGS. 7A and 7B illustrate an example of an EAP film or membrane 10 structure. A thin elastomeric dielectric film or layer 12 is sandwiched between compliant or stretchable electrode plates or layers 14 and 16, thereby forming a capacitive structure or film. The length “1” and width “w” of the dielectric layer, as well as that of the composite structure, are much greater than its thickness “t”. Typically, the dielectric layer has a thickness in range from about 10 μm to about 100 μm, with the total thickness of the structure in the range from about 25 μm to about 10 μm. Additionally, it is desirable to select the elastic modulus, thickness, and/or the microgeometry of electrodes 14, 16 such that the additional stiffness they contribute to the actuator is generally less than the stiffness of the dielectric layer 12, which has a relatively low modulus of elasticity, i.e., less than about 100 MPa and more typically less than about 10 MPa, but is likely thicker than each of the electrodes. Electrodes suitable for use with these compliant capacitive structures are those capable of withstanding cyclic strains greater than about 1% without failure due to mechanical fatigue.

As seen in FIG. 7B, when a voltage is applied across the electrodes, the unlike charges in the two electrodes 14, 16 are attracted to each other and these electrostatic attractive forces compress the dielectric film 12 (along the Z-axis). The dielectric film 12 is thereby caused to deflect with a change in electric field. As electrodes 14, 16 are compliant, they change shape with dielectric layer 12. Generally speaking, deflection refers to any displacement, expansion, contraction, torsion, linear or area strain, or any other deformation of a portion of dielectric film 12. Depending on the form fit architecture, e.g., a frame, in which capacitive structure 10 is employed (collectively referred to as a “transducer”), this deflection may be used to produce mechanical work. Various different transducer architectures are disclosed and described in the above-identified patent references.

With a voltage applied, the transducer film 10 continues to deflect until mechanical forces balance the electrostatic forces driving the deflection. The mechanical forces include elastic restoring forces of the dielectric layer 12, the compliance or stretching of the electrodes 14, 16 and any external resistance provided by a device and/or load coupled to transducer 10. The resultant deflection of the transducer 10 as a result of the applied voltage may also depend on a number of other factors such as the dielectric constant of the elastomeric material and its size and stiffness. Removal of the voltage difference and the induced charge causes the reverse effects.

In some cases, the electrodes 14 and 16 may cover a limited portion of dielectric film 12 relative to the total area of the film. This may be done to prevent electrical breakdown around the edge of the dielectric or achieve customized deflections in certain portions thereof. Dielectric material outside an active area (the latter being a portion of the dielectric material having sufficient electrostatic force to enable deflection of that portion) may be caused to act as an external spring force on the active area during deflection. More specifically, material outside the active area may resist or enhance active area deflection by its contraction or expansion.

The dielectric film 12 may be pre-strained. The pre-strain improves conversion between electrical and mechanical energy, i.e., the pre-strain allows the dielectric film 12 to deflect more and provide greater mechanical work. Pre-strain of a film may be described as the change in dimension in a direction after pre-straining relative to the dimension in that direction before pre-straining. The pre-strain may comprise elastic deformation of the dielectric film and be formed, for example, by stretching the film in tension and fixing one or more of the edges while stretched. The pre-strain may be imposed at the boundaries of the film or for only a portion of the film and may be implemented by using a rigid frame or by stiffening a portion of the film.

The transducer structure of FIGS. 7A and 7B and other similar compliant structures and the details of their constructs are more fully described in many of the referenced patents and publications disclosed herein.

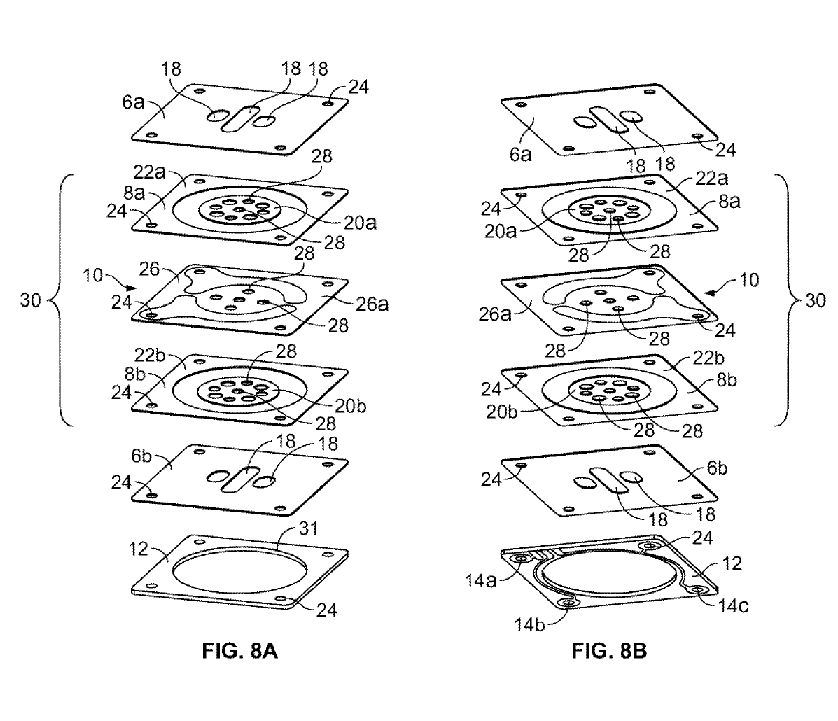

In addition to the EAP films described above, sensory or haptic feedback user interface devices can include EAP transducers designed to produce lateral movement. For example, various components including, from top to bottom as illustrated in FIGS. 8A and 8B, actuator 30 having an electroactive polymer (EAP) transducer 10 in the form of an elastic film which converts electrical energy to mechanical energy (as noted above). The resulting mechanical energy is in the form of physical “displacement” of an output member, here in the form of a disc 28.

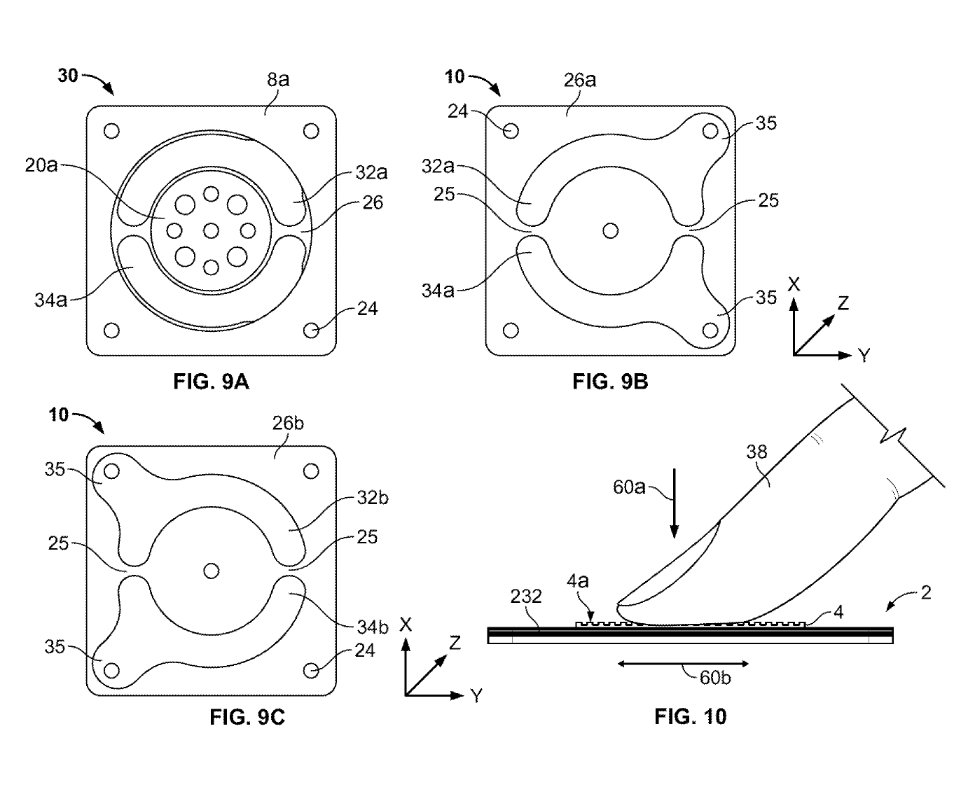

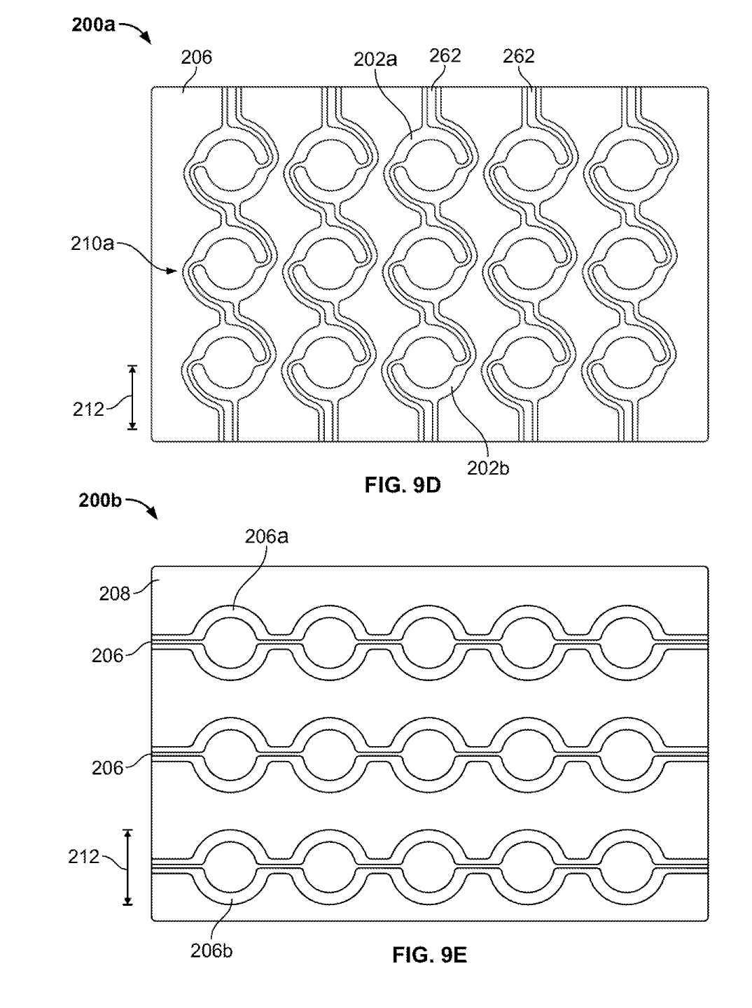

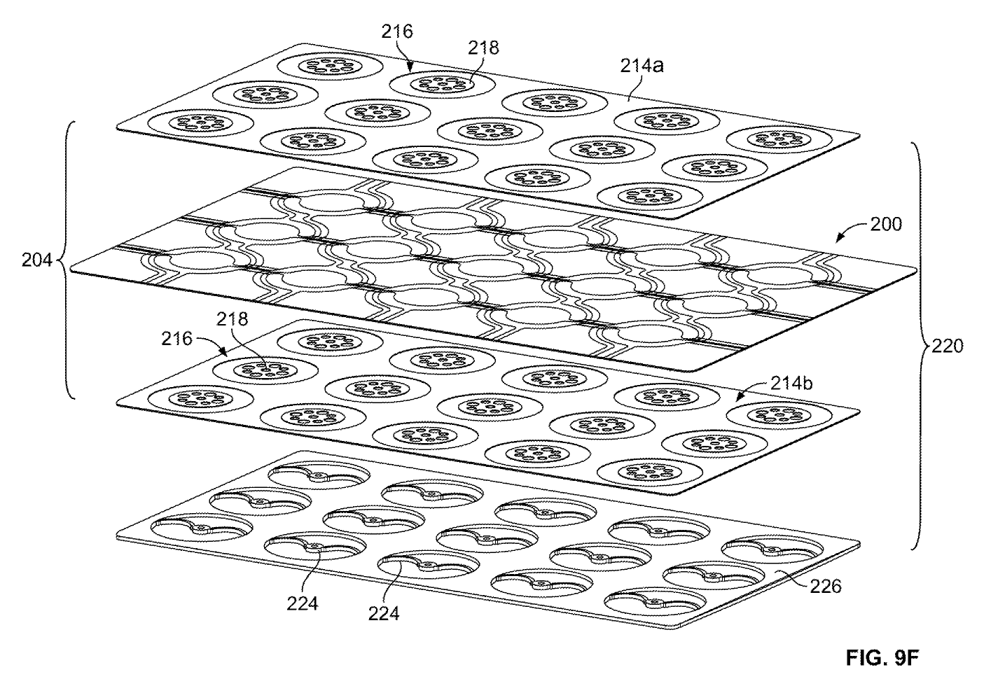

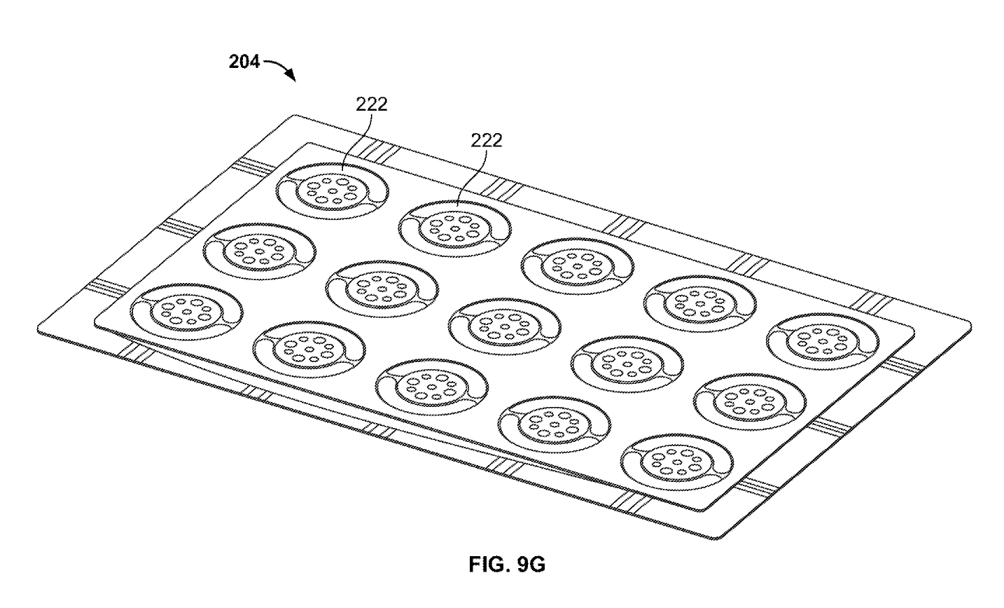

With reference to FIGS. 9A-9C, EAP transducer film 10 comprises two working pairs of thin elastic electrodes 32a, 32b and 34a, 34b where each working pair is separated by a thin layer of elastomeric dielectric polymer 26 (e.g., made of acrylate, silicone, urethane, thermoplastic elastomer, hydrocarbon rubber, flurorelastomer, or the like). When a voltage difference is applied across the oppositely-charged electrodes of each working pair (i.e., across electrodes 32a and 32b, and across electrodes 34a and 34b), the opposed electrodes attract each other thereby compressing the dielectric polymer layer 26 therebetween. As the electrodes are pulled closer together, the dielectric polymer 26 becomes thinner (i.e., the z-axis component contracts) as it expands in the planar directions (i.e., the x- and y-axes components expand) (see FIGS. 9B and 9C for axis references). Furthermore, like charges distributed across each electrode cause the conductive particles embedded within that electrode to repel one another, thereby contributing to the expansion of the elastic electrodes and dielectric films. The dielectric layer 26 is thereby caused to deflect with a change in electric field. As the electrode material is also compliant, the electrode layers change shape along with dielectric layer 26. Generally speaking, deflection refers to any displacement, expansion, contraction, torsion, linear or area strain, or any other deformation of a portion of dielectric layer 26. This deflection may be used to produce mechanical work.

In fabricating transducer 20, elastic film is stretched and held in a pre-strained condition by two opposing rigid frame sides 8a, 8b. It has been observed that the pre-strain improves the dielectric strength of the polymer layer 26, thereby improving conversion between electrical and mechanical energy, i.e., the pre-strain allows the film to deflect more and provide greater mechanical work. Typically, the electrode material is applied after pre-straining the polymer layer, but may be applied beforehand. The two electrodes provided on the same side of layer 26, referred to herein as same-side electrode pairs, i.e., electrodes 32a and 34a on top side 26a of dielectric layer 26 (see FIG. 9B) and electrodes 32b and 34b on bottom side 26b of dielectric layer 26 (see FIG. 9C), are electrically isolated from each other by inactive areas or gaps 25. The opposed electrodes on the opposite sides of the polymer layer from two sets of working electrode pairs, i.e., electrodes 32a and 32b for one working electrode pair and electrodes 34a and 34b for another working electrode pair. Each same-side electrode pair preferably has the same polarity, while the polarity of the electrodes of each working electrode pair are opposite each other, i.e., electrodes 32a and 32b are oppositely charged and electrodes 34a and 34b are oppositely charged. Each electrode has an electrical contact portion 35 configured for electrical connection to a voltage source (not shown).

In the illustrated embodiment, each of the electrodes has a semi-circular configuration where the same-side electrode pairs define a substantially circular pattern for accommodating a centrally disposed, rigid output disc 20a, 20b on each side of dielectric layer 26. Discs 20a, 20b, the functions of which are discussed below, are secured to the centrally exposed outer surfaces 26a, 26b of polymer layer 26, thereby sandwiching layer 26 therebetween. The coupling between the discs and film may be mechanical or be provided by an adhesive bond. Generally, the discs 20a, 20b will be sized relative to the transducer frame 22a, 22b. More specifically, the ratio of the disc diameter to the inner annular diameter of the frame will be such so as to adequately distribute stress applied to transducer film 10. The greater the ratio of the disc diameter to the frame diameter, the greater the force of the feedback signal or movement but with a lower linear displacement of the disc. Alternately, the lower the ratio, the lower the output force and the greater the linear displacement.

Depending upon the electrode configurations, transducer 10 can be capable of functioning in either a single or a two-phase mode. In the manner configured, the mechanical displacement of the output component, i.e., the two coupled discs 20a and 20b, of the subject sensory feedback device described above is lateral rather than vertical. In other words, instead of the sensory feedback signal being a force in a. direction perpendicular to the display surface 232 of the user interface and parallel to the input force (designated by arrow 60a in FIG. 10) applied by the user's finger 38 (but in the opposing or upward direction), the sensed feedback or output force (designated by double-head arrow 60b in FIG. 10) of the sensory/haptic feedback devices of the present invention is in a direction parallel to the display surface 232 and perpendicular to input force 60a. Depending on the rotational alignment of the electrode pairs about an axis perpendicular to the plane of transducer 10 and relative to the position of the display surface 232 mode in which the transducer is operated (i.e., single phase or two phase), this lateral movement may be in any direction or directions within 360°. For example, the lateral feedback motion may be from side to side or up and down (both are two-phase actuations) relative to the forward direction of the user's finger (or palm or grip, etc.). While those skilled in the art will recognize certain other actuator configurations which provide a feedback displacement which is transverse or perpendicular to the contact surface of the haptic feedback device, the overall profile of a device so configured may be greater than the aforementioned design.

FIGS. 9D-9G illustrate an example of an array of electro-active polymers that can be placed across the display screen of the device. In this example, voltage and ground sides 200a and 200b, respectively, of an EAP film array 200 (see FIG. 9F) for use in an array of EAP actuators for use in the tactile feedback devices of the present invention. Film array 200 includes an electrode array provided in a matrix configuration to increase space and power efficiency. The high voltage side 200a of the EAP film array provides electrode patterns 202 running in vertically (according to the view point illustrated in FIG. 9D) on dielectric film 208 material. Each pattern 202 includes a pair of high voltage lines 202a, 202b. The opposite or ground side 200b of the EAP film array provides electrode patterns 206 running transversally relative to the high voltage electrodes, i.e., horizontally. Each pattern 206 includes a pair of ground lines 206a, 206b. Each pair of opposing high voltage and ground lines (202a, 206a and 202b, 206b) provides a separately activatable electrode pair such that activation of the opposing electrode pairs provides a two-phase output motion in the directions illustrated by arrows 212. The assembled EAP film array 200 (illustrating the intersecting pattern of electrodes on top and bottom sides of dielectric film 208) is provided in FIG. 9F within an exploded view of an array 204 of EAP transducers 222, the latter of which is illustrated in its assembled form in FIG. 9G. EAP film array 200 is sandwiched between opposing frame arrays 214a, 214b, with each individual frame segment 216 within each of the two arrays defined by a centrally positioned output disc 218 within an open area. Each combination of frame/disc segments 216 and electrode configurations form an EAP transducer 222. Depending on the application and type of actuator desired, additional layers of components may be added to transducer array 204. The transducer array 220 may be incorporated in whole to a user interface array, such as a display screen, sensor surface, or touch pad, for example.

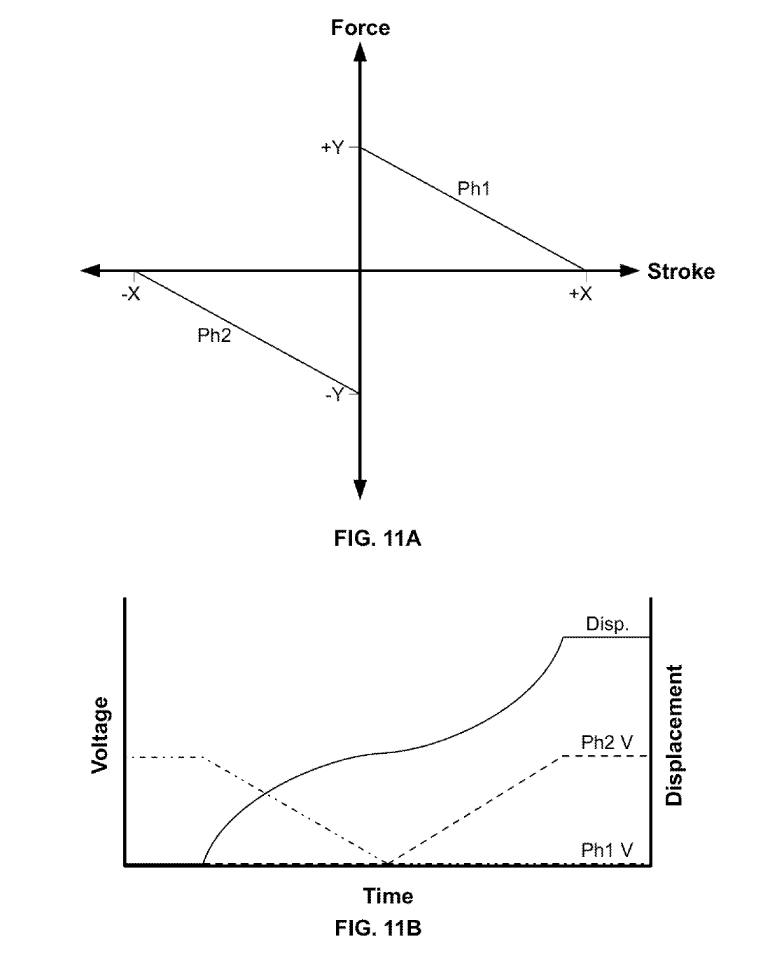

When operating sensory/haptic feedback device 2 in single-phase mode, only one working pair of electrodes of actuator 30 would be activated at any one time. The single-phase operation of actuator 30 may be controlled using a single high voltage power supply. As the voltage applied to the single-selected working electrode pair is increased, the activated portion (one half) of the transducer film will expand, thereby moving the output disc 20 in-plane in the direction of the inactive portion of the transducer film. FIG. 11A illustrates the force-stroke relationship of the sensory feedback signal (i.e., output disc displacement) of actuator 30 relative to neutral position when alternatingly activating the two working electrode pairs in single-phase mode. As illustrated, the respective forces and displacements of the output disc are equal to each other but in opposite directions. FIG. 11B illustrates the resulting non-linear relationship of the applied voltage to the output displacement of the actuator when operated in this single-phase mode. The “mechanical” coupling of the two electrode pairs by way of the shared dielectric film may be such as to move the output disc in opposite directions. Thus, when both electrode pairs are operated, albeit independently of each other, application of a voltage to the first working electrode pair (phase 1) will move the output disc 20 in one direction, and application of a voltage to the second working electrode pair (phase 2) will move the output disc 20 in the opposite direction. As the various plots of FIG. 11B reflect, as the voltage is varied linearly, the displacement of the actuator is non-linear. The acceleration of the output disk during displacement can also be controlled through the synchronized operation of the two phases to enhance the haptic feedback effect. The actuator can also be partitioned into more than two phases that can be independently activated to enable more complex motion of the output disk.

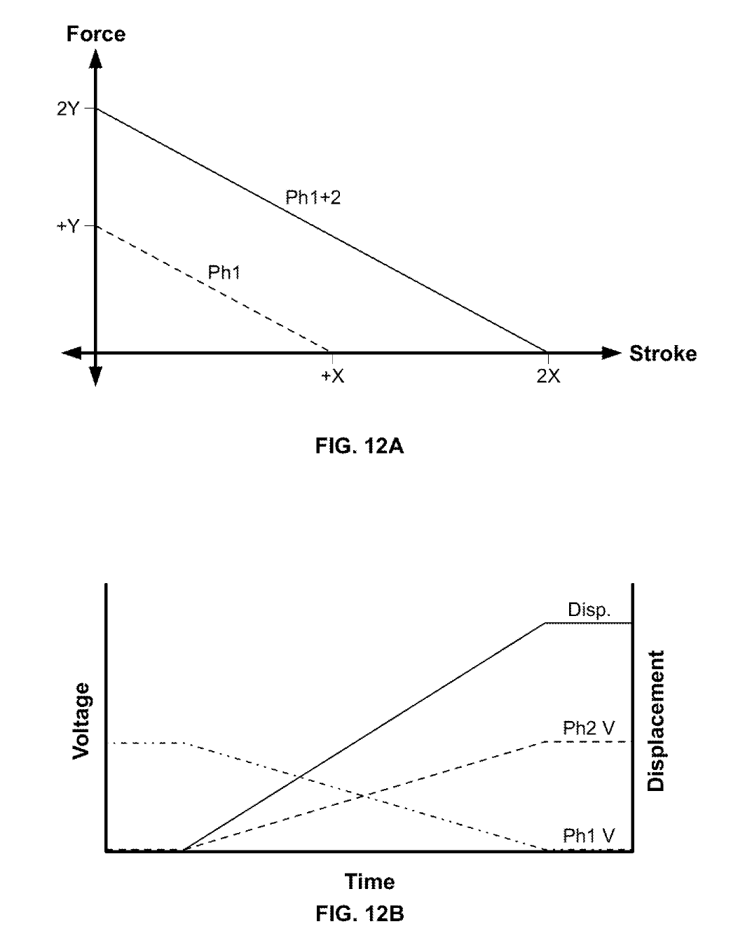

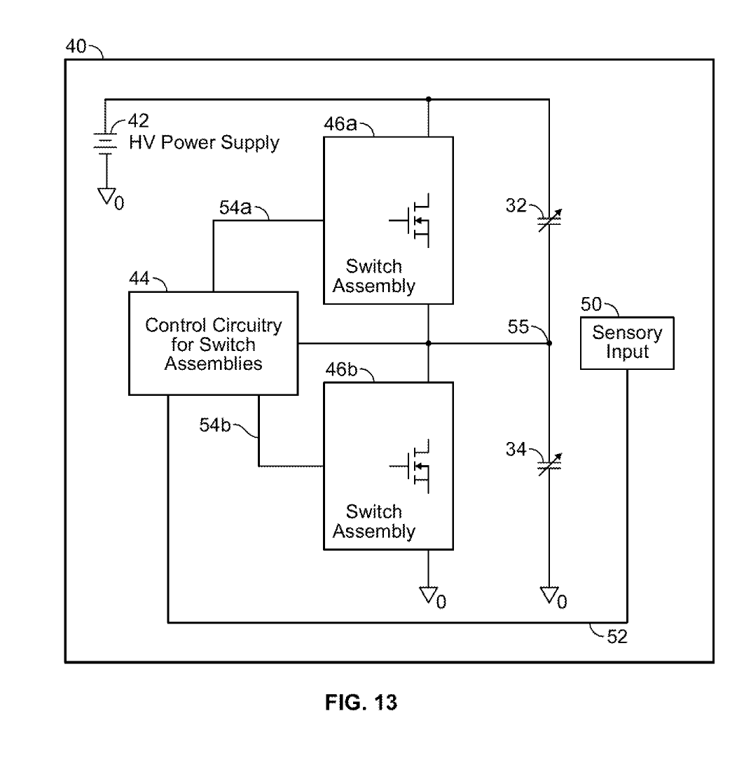

To effect a greater displacement of the output member or component, and thus provide a greater sensory feedback signal to the user, actuator 30 is operated in a two-phase mode, i.e., activating both portions of the actuator simultaneously. FIG. 12A illustrates the force-stroke relationship of the sensory feedback signal of the output disc when the actuator is operated in two-phase mode. As illustrated, both the force and stroke of the two portions 32, 34 of the actuator in this mode are in the same direction and have double the magnitude than the force and stroke of the actuator when operated in single-phase mode. FIG. 12B illustrates the resulting linear relationship of the applied voltage to the output displacement of the actuator when operated in this two-phase mode. By connecting the mechanically coupled portions 32, 34 of the actuator electrically in series and controlling their common node 55, such as in the manner illustrated in the block diagraph 40 of FIG. 13, the relationship between the voltage of the common node 55 and the displacement (or blocked force) of the output member (in whatever configuration) approach a linear correlation. In this mode of operation, the non-linear voltage responses of the two portions 32, 34 of actuator 30 effectively cancel each other out to produce a linear voltage response. With the use of control circuitry 44 and switching assemblies 46a, 46b, one for each portion of the actuator, this linear relationship allows the performance of the actuator to be fine-tuned and modulated by the use of varying types of waveforms supplied to the switch assemblies by the control circuitry. Another advantage of using circuit 40 is the ability to reduce the number of switching circuits and power supplies needed to operate the sensory feedback device. Without the use of circuit 40, two independent power supplies and four switching assemblies would be required. Thus, the complexity and cost of the circuitry are reduced while the relationship between the control voltage and the actuator displacement are improved, i.e., made more linear.

Various types of mechanisms may be employed to communicate the input force 60a from the user to effect the desired sensory feedback 60b (see FIG. 10). For example, a capacitive or resistive sensor 50 (see FIG. 13) may be housed within the user interface pad 4 to sense the mechanical force exerted on the user contact surface input by the user. The electrical output 52 from sensor 50 is supplied to the control circuitry 44 that in turn triggers the switch assemblies 46a, 46b to apply the voltage from power supply 42 to the respective transducer portions 32, 34 of the sensory feedback device in accordance with the mode and waveform provided by the control circuitry.

Another variation of the present invention involves the hermetic sealing of the EAP actuators to minimize any effects of humidity or moisture condensation that may occur on the EAP film. For the various embodiments described below, the EAP actuator is sealed in a barrier film substantially separately from the other components of the tactile feedback device. The barrier film or casing may be made of, such as foil, which is preferably heat sealed or the like to minimize the leakage of moisture to within the sealed film. Portions of the barrier film or casing can be made of a compliant material to allow improved mechanical coupling of the actuator inside the casing to a point external to the casing. Each of these device embodiments enables coupling of the feedback motion of the actuator's output member to the contact surface of the user input surface, e.g., keypad, while minimizing any compromise in the hermetically sealed actuator package. Various exemplary means for coupling the motion of the actuator to the user interface contact surface are also provided. Regarding methodology, the subject methods may include each of the mechanical and/or activities associated with use of the devices described. As such, methodology implicit to the use of the devices described forms part of the invention. Other methods may focus on fabrication of such devices.

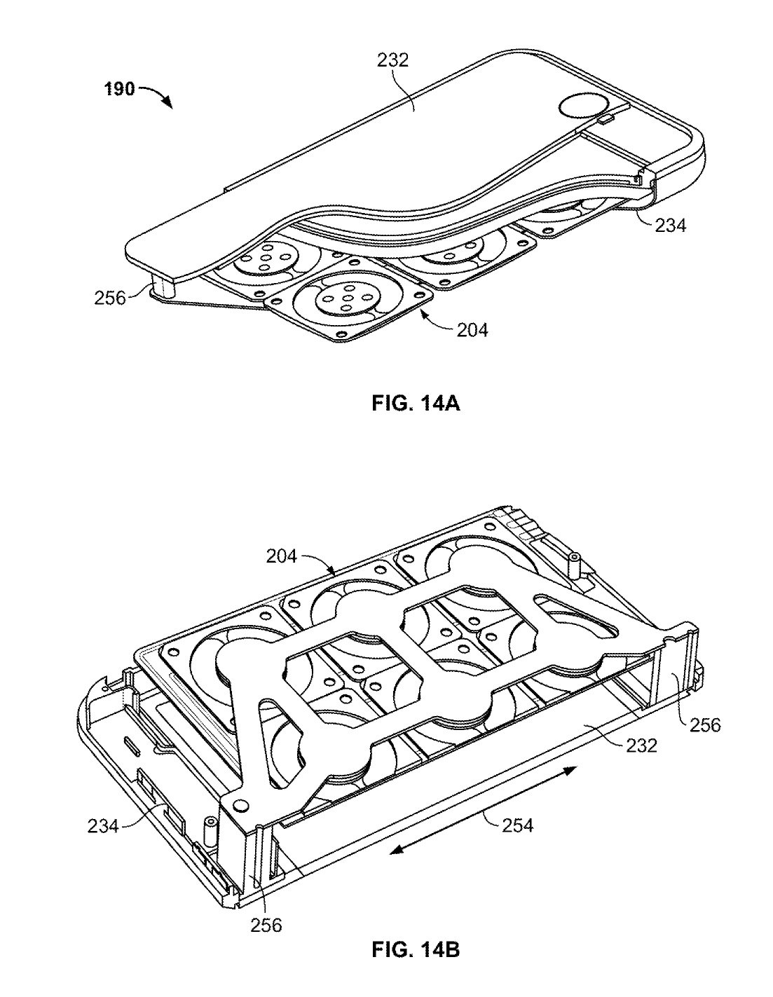

FIG. 14A shows an example of a planar array of EAP actuators 204 coupled to a user input device 190. As show, the array of EAP actuators 204 covers a portion of the screen 232 and is coupled to a frame 234 of the device 190 via a stand off 256. In this variation, the stand off 256 permits clearance for movement of the actuators 204 and screen 232. In one variation of the device 190 the array of actuators 204 can be multiple discrete actuators or an array of actuators behind the user interface surface or screen 232 depending upon the desired application. FIG. 14B shows a bottom view of the device 190 of FIG. 14A. As shown by arrow 254 the EAP actuators 204 can allow for movement of the screen 232 along an axis either as an alternative to, or in combination with movement in a direction normal to the screen 232.

As for other details of the present invention, materials and alternate related configurations may be employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Stated otherwise, unless specifically defined herein, all technical and scientific terms used herein are to be given as broad a commonly understood meaning as possible while maintaining claim validity.

In all, the breadth of the present invention is not to be limited by the examples provided. That being said, we claim:

What is claimed is:

1. A user interface device for displaying information to a user, the user interface comprising:
a screen having a user interface surface configured for tactile contact by a user and a sensor plate, the screen being configured to display the information;
a frame about at least a portion of the screen; and
an electroactive polymer material coupled between the screen and the frame, wherein an input signal generated by the user causes an electrical field to be applied to the electroactive polymer material causing the electroactive polymer material to displace at least one of the screen and sensor panel in a manner that produces a force sufficient for tactile observation by the user.

2. The user interface device of claim 1, where the screen is configured for tactile contact by a user, and where tactile contact by the user results in generation of the input signal.

3. The user interface device of claim 1, where a data entry surface is configured for accepting user input and for generation of the input signal.

4. The user interface device of claim 1, further comprising a control system for controlling the amount of displacement of the electroactive polymer transducer in response to a triggering force against the screen.

5. The user interface device of claim 1, wherein the movement of the screen is in a lateral direction relative to the frame.

6. The user interface device of claim 1, wherein the output member is mechanically coupled to the user contact surface.

7. The user interface device of claim 1, where the electroactive polymer material is encapsulated to form a gasket and where the gasket is mechanically coupled between the frame and the screen.

8. The user interface device of claim 1, where the electroactive polymer material is directly coupled between the frame and the screen.

9. The user interface device of claim 8, further comprising at least one spring member located between the frame and the screen.

10. The user interface device of claim 1, further comprising a flexible layer that covers at least a portion of the screen.

11. The user interface device of claim 1, where the electroactive polymer material comprises at least an electro active transducer having at least one spring member.

12. The user interface device of claim 11, where the electro active transducer comprises at least a pair of opposing electroactive polymer films.

13. The user interface device of claim 11, wherein the electroactive transducer further comprises a negative spring rate bias.

14. The user interface device of claim 1, where the electroactive polymer material is coupled to the display screen at a plurality of locations.

15. The user interface device of 14, where the electroactive polymer material comprises a plurality of corrugations or folds.

16. The user interface device of claim 1, where the electroactive polymer material comprises an array of electro active polymer materials adjacent to at least a portion of the screen that is spaced from the frame.

17. The user interface device of claim 1, where the screen comprises a touchpad.

18. A user interface device for displaying information to a user, the user interface comprising:
a screen having a sensor surface configured for tactile contact by a user and a sensor plate, the screen being configured to display the information;
a frame about at least a portion of the screen; and
an electroactive polymer material coupled between the sensor surface and the frame, wherein an input signal generated by the user causes an electrical field to be applied to the electroactive polymer material causing the electroactive polymer material to displace at least one of the screen and sensor surface in a manner that produces a force sufficient for tactile observation by the user.

19. The user interface device of claim 18, where the sensor surface is configured for tactile contact by a user, and where tactile contact by the user results in generation of the input signal.

20. The user interface device of claim 18, where a data entry surface is configured for accepting user input and for generation of the input signal.

21. The user interface device of claim 18, further comprising a control system for controlling the amount of displacement of the electroactive polymer transducer in response to a triggering force against the sensor plate.

22. The user interface device of claim 18, wherein the movement of e sensor plate is in a lateral direction relative to the frame.

23. The user interface device of claim 18, wherein the output member is mechanically coupled to the user contact surface.

24. The user interface device of claim 18, where the electroactive polymer material is encapsulated to form a gasket and where the gasket is mechanically coupled between the frame and the sensor surface.

25. The user interface device of claim 18, where the electroactive polymer material is directly coupled between the frame and the sensor surface.

26. The user interface device of claim 25, further comprising at least one spring member located between the frame and the sensor surface.

27. The user interface device of claim 18, further comprising a flexible layer that covers at least a portion of the screen.

28. The user interface device of claim 18, where the electroactive polymer material comprises at least an electro active transducer having at least one spring member.

29. The user interface device of claim 28, where the electro active transducer comprises at least a pair of opposing electroactive polymer films.

30. The user interface device of claim 28, wherein the electroactive transducer further comprises a negative spring rate bias.

31. The user interface device of claim 18, where the electroactive polymer material is coupled to the display screen at a plurality of locations.

32. The user interface device of 31, where the electroactive polymer material comprises a plurality of corrugations or folds.

33. The user interface device of claim 18, wherein the sealing material forms a gasket between the user contact surface and the transducer.

34. The user interface device of claim 18, wherein the sealing material encases the transducer.

35. The user interface device of claim 18, wherein the electroactive polymer material is activatable in two phases.

36. The user interface device of claim 18, where the electroactive polymer material comprises an array of electro active polymer materials adjacent to at least a portion of the sensor surface that is spaced from the frame.

37. The user interface device of claim 18, where the screen comprises a touchpad.
